(19) United States
(12) Patent Application Publication
(10) Pub. No.: US 2017/0244326 A1
(43) Pub. Date: Aug. 24, 2017

(54) MULTI-OUTPUT REGULATOR WITH JOINT FEEDBACK

(71) Applicant: VIASAT, INC., Carlsbad, CA (US)

(72) Inventors: Branislav Petrovic, La Jolla, CA (US); Jeff Schafer, Carlsbad, CA (US)

(21) Appl. No.: 15/052,849

(22) Filed: Feb. 24, 2016

(51) Int. Cl. H02M 3/335

(52) U.S. Cl. CPC H02M 3/33507

(57) ABSTRACT

A multi-output switched mode power supply may include a power circuit and a controller to control the power circuit. A combiner circuit may produce a single feedback signal based on the regulated output voltages produced by the switched mode power supply.

### BACKGROUND

DC-DC converters are electronic circuits used to change DC electrical power from one voltage level to another. DC-DC converters may be found in electronic devices including computers, hand held devices such as computer tablets, smart phones, etc., home entertainment equipment such as DVD players, DVRs (digital video recorders), and the like. DC-DC converters may include AC to DC converters, for example, to convert AC power (e.g., 120 VAC) provide a DC level input voltage (e.g., 120 VDC) that can then be regulated (stepped down) to produce various DC levels (e.g., 5V, 12V, etc.).

Switching regulators may be used to provide DC-DC conversion. Switching regulators provide efficient conversion because less energy is lost during the conversion. Consequently, smaller components and less thermal management are required. Switching regulators can step down an input voltage to produce a lower output voltage (so called buck operation), or step up an input voltage to produce a higher output voltage (so called boost operation). In some configurations, energy can be transferred using a transformer to provide electrical isolation between the input voltage and the output voltage.

### SUMMARY

In accordance with aspects of the present disclosure, a multi-output switched mode power supply may include a power circuit having at least a first output terminal and a second output terminal. A controller may control the power circuit to produce a first regulated voltage on the first output terminal and a second regulated voltage on the second output terminal. A combiner circuit may produce a single feedback signal based on the first regulated voltage and the second regulated voltage used to control the power circuit to adjust the first regulated voltage and the second regulated voltage.

In accordance with aspects of the present disclosure, a method in a multi-output switched mode power supply may include generating at least a first regulated voltage and a second regulated voltage using a single controller. A single feedback signal may be produced using the first regulated voltage and the second regulated voltage. The single feedback signal may be used in the single controller to adjust the first regulated voltage and the second regulated voltage.

In accordance with aspects of the present disclosure, a multi-output switched mode power supply may include: means for generating at least a first regulated voltage and a second regulated voltage; means for outputting the first regulated voltage and the second regulated voltage, respectively, on a first output and a second output; means for producing a single feedback signal based on the first regulated voltage and the second regulated voltage; and means for adjusting the first regulated voltage and the second regulated voltage using the single feedback signal.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 shows a block diagram representation of a switched mode power supply in accordance with the present disclosure.

FIGS. 2 and 2A show details of a switched mode power supply in accordance with some embodiments of the present disclosure.

FIG. 2B shows details of a switched mode power supply in accordance with some embodiments of the present disclosure.

FIGS. 3 and 3A show details of a switched mode power supply in accordance with other embodiments of the present disclosure.

FIG. 4 shows an embodiment in accordance with the present disclosure using an AC input supply.

FIGS. 5 and 5A show embodiments in accordance with the present disclosure based on switched capacitors.

FIG. 6 shows a block diagram illustrating example components of a satellite user terminal comprising an indoor unit and an outdoor unit in accordance with the present disclosure.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

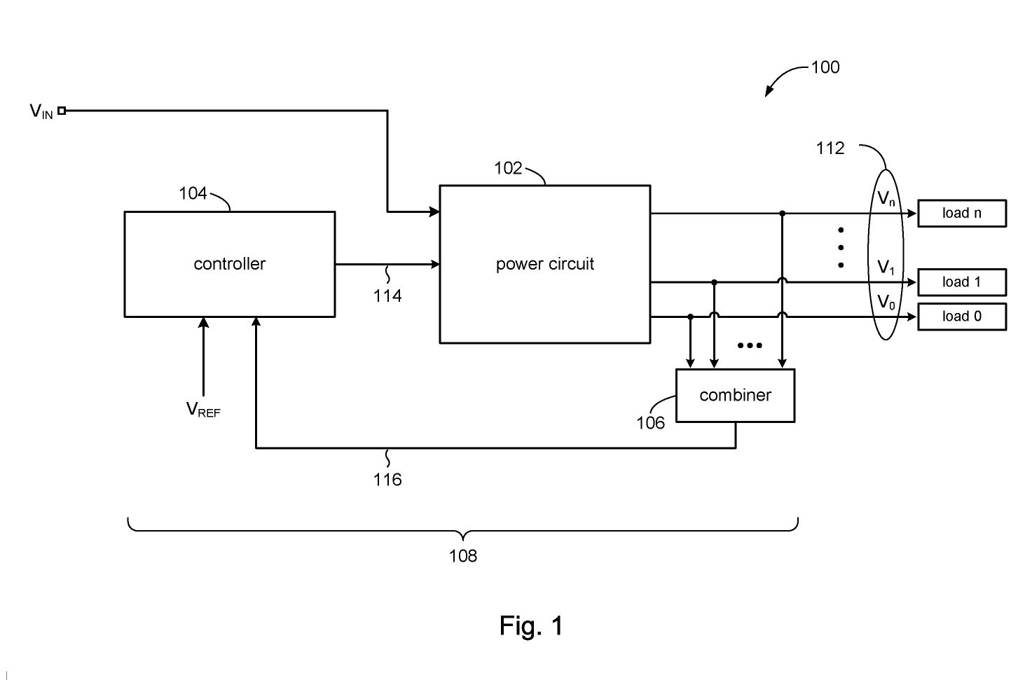

FIG. 1 is a block diagram depicting a generalized representation of a switched mode (switching) power supply or regulator 100 in accordance with the present disclosure. The switched mode power supply 100 may be a multi-output switched mode power supply. In some embodiments, for example, the switched mode power supply 100 may produce or otherwise output several regulated output voltages V₀-Vₙ from an input voltage V_{IN} (e.g., from an input supply, not shown). The output voltages V₀-Vₙ may provide power to respective loads connected to the switched mode power supply 100.

The switched mode power supply 100 may include means for generating at least a first regulated voltage and a second regulated voltage. In some embodiments, for example, the switched mode power supply 100 may include a power circuit 102 having several outputs or output terminals 112. Each output terminal 112 may output a respective output voltage, V₀-Vₙ.

The switched mode power supply 100 may include means for adjusting the first regulated voltage and the second regulated voltage using a single feedback signal. In some embodiments, for example, the switched mode power supply 100 may include a controller 104 connected to the power circuit 102. The controller 104 may produce a control signal 114 to control the power circuit 102 to produce the output voltages V₀-Vₙ. In accordance with some embodiments of the present disclosure, the switched mode power supply 100 may include only the one single controller 104 to control power circuit 102. In accordance with some embodiments of the present disclosure, the switched mode power supply 100 may use only the one single control signal 114 to control power circuit 102.

The switched mode power supply 100 may include means for producing a single feedback signal based on the first regulated voltage and the second regulated voltage. In some embodiments, for example, the switched mode power supply 100 may include a combiner circuit 106. The outputs 112 of the power circuit 102 may be connected to the combiner circuit 106. In accordance with the present disclosure, the combiner circuit 106 may produce a feedback signal 116 based on a combination of the output voltages V₀-Vₙ. The feedback signal 116 may be provided to the controller 104 and used to produce the control signal 114. The output voltages V₀-Vₙ may therefore be regulated in accordance with the feedback signal 116. In some embodiments, the control signal 114 may be based on a reference voltage V_{ref} in combination with the feedback signal 116. The reference voltage V_{ref} may serve as a reference against which to compare the feedback signal 116 in order to generate an error signal. The error signal may serve as the control signal 114 regulate or otherwise vary the output voltages V₀-Vₙ in a way that minimizes the error signal. A further description of these aspects of the present disclosure is provided below.

The combiner circuit 106 and feedback signal 116 may define a feedback path 108 in the switched mode power supply 100. In some embodiments, the switched mode power supply 100 may include only the one single feedback path 108.

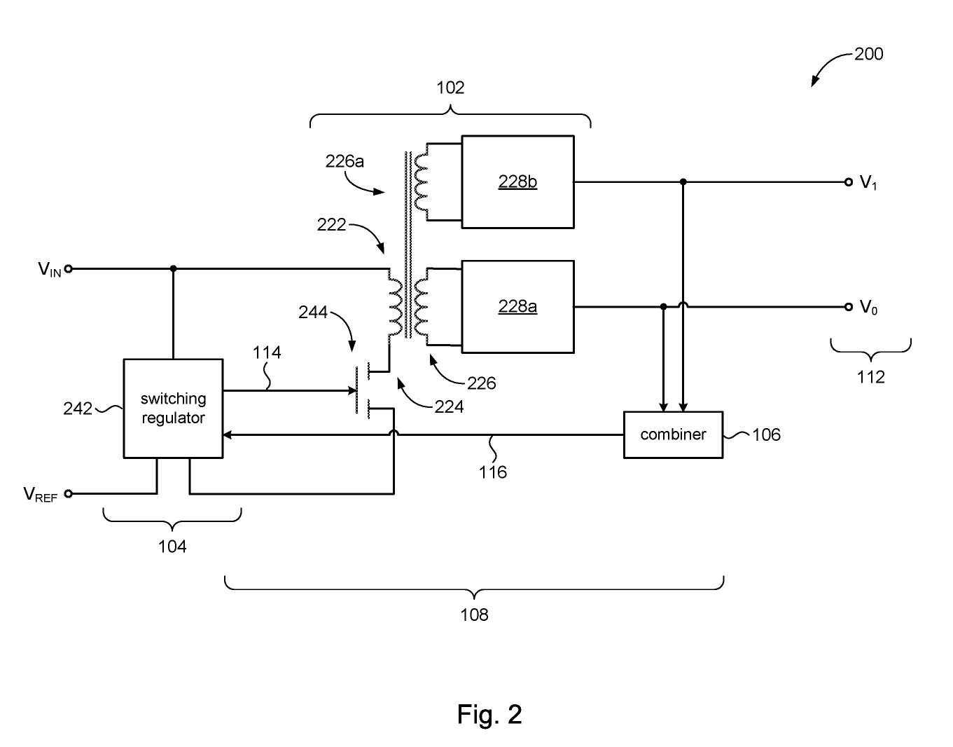

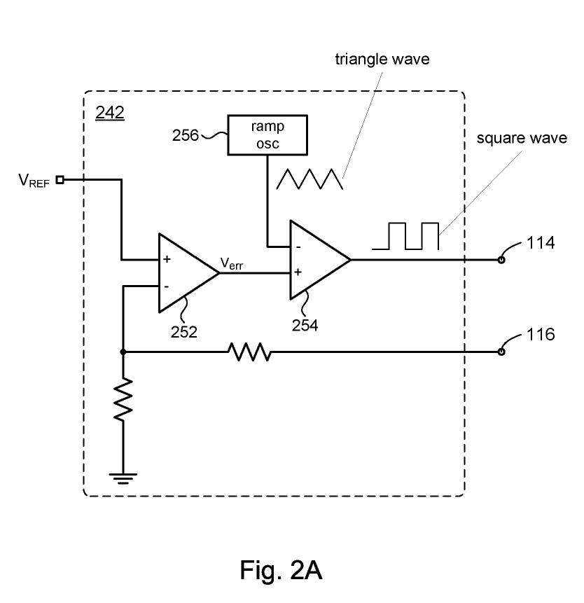

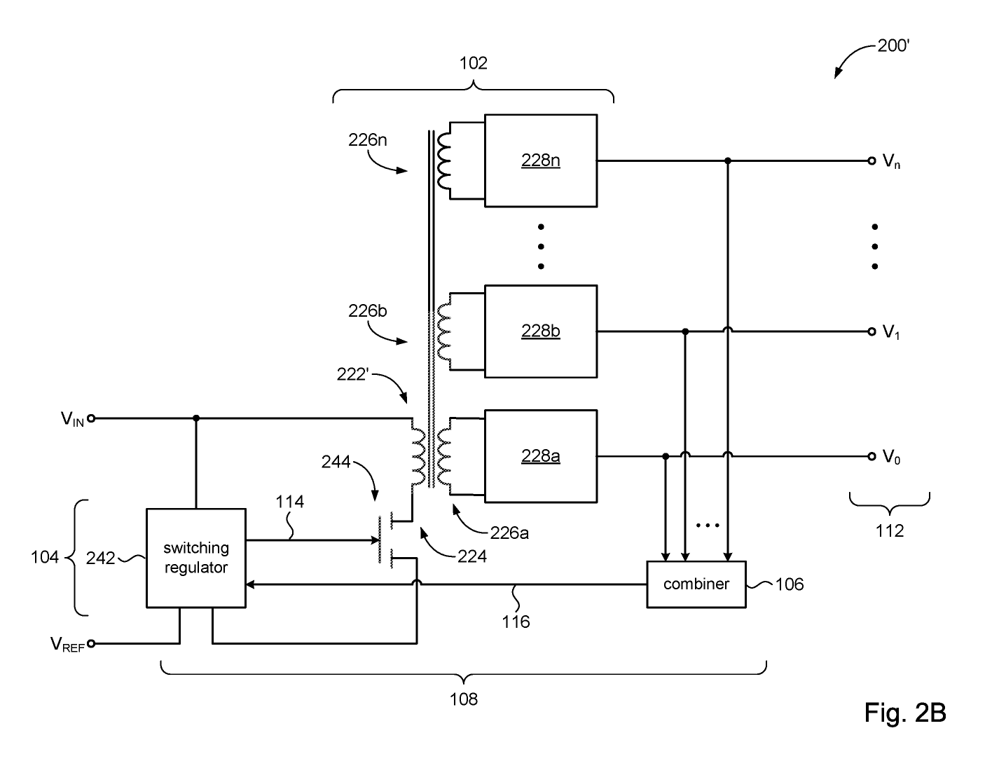

FIG. 2 shows some details of an example of a switched mode power supply 200 in accordance with some embodiments of the present disclosure. In some embodiments, the switched mode power supply 200 may include power circuit 102 comprising a switching device 244 and a transformer 222. The switching device 244 may be a power FET or any suitable switching circuitry. The power circuit 102 may further include means for outputting the first regulated voltage and the second regulated voltage, respectively, on a first output and a second output (e.g., output terminals 112). In some embodiments, for example, the power circuit 102 may include output modules 228a, 228b.

The transformer 222 may include a primary 224 and a secondary 226. The primary 224 may be connected across an input voltage V_{IN} and one of the terminals (e.g., a drain terminal on an FET) of the switching device 244. The secondary 226 may be connected across one of the output modules 228a in order to produce output voltage V₀ at one of the output terminals 112 of the switched mode power supply 200. The transformer 222 may include an additional secondary 226a, which may be connected across another output module 228b in order to produce an output voltage V₁ at another one of the output terminals 112 of switched mode power supply 200. It will be appreciated that, in other embodiments, any suitable inductive element may be used as an alternative to transformer 222. In some embodiments, for example, the inductive element may be an autotransformer.

The switched mode power supply 200 may include controller 104 to control the power circuit 102. In some embodiments, the controller 104 may comprise a switching regulator 242. In some embodiments, the input voltage V_{IN} may provide power to the switching regulator 242. In other embodiments, the switching regulator 242 may be powered from a voltage other than input voltage V_{IN}. The switching regulator 242 may generate control signal 114. The control signal 114, in turn, may be applied to a control input (e.g., a gate terminal on an FET) of the switching device 244 to control switching of the switching device 244 between an ON (conducting) state and an OFF (non-conducting) state.

The switched mode power supply 200 may include combiner circuit 106 to receive output voltages V₀, V₁ from respective output modules 228a, 228b. In accordance with the present disclosure, the combiner circuit 106 may produce the single feedback signal 116 based on a combination of the output voltages V₀, V₁. The feedback signal 116 may be provided to the switching regulator 242 to control operation of the switching regulator 242, thus completing feedback loop 108.

The switching regulator 242 may comprise any suitable switching controller design. Referring to FIG. 2A, for example, in some embodiments the switching regulator 242 may include an error amplifier 252 and a comparator 254. The feedback signal 116 may be provided to an input (e.g., inverting input) of the error amplifier 252. A reference voltage V_{ref} may be applied to the another input (e.g., non-inverting input) of the error amplifier 252. The reference voltage V_{ref} may be derived from the input voltage V_{IN}, or may be internally generated. The output of the error amplifier 252 (e.g., an error signal, Vₑᵣᵣ) may be compared to an oscillator ramp signal (e.g., sawtooth signal, triangle wave, etc.) produced by a ramp oscillator 256 to produce control signal 114. The embodiment shown in FIG. 2A illustrates an example of an analog control loop. It will be appreciated, however, that in other embodiments, the switching regulator 242 may be digital control loop.

FIG. 2B depicts a generalized configuration of the switched mode power supply 200 of FIG. 2. In accordance with the present disclosure, a switched mode power supply 200′ may generally comprise two or more output modules 228a, 228b to 228n to produce two or more output voltages V₀, V₁, Vₙ. The switched mode power supply 200′ may include power circuit 102 comprising a transformer 222′ having two or more secondaries 226a, 226b to 226n. Each secondary 226, 226a, 226b may be connected to a respective output module 228a, 228b to 228n to provide respective output voltages V₀, V₁, Vₙ at output terminals 112 of the switched mode power supply 200′. A combiner circuit 106 may combine the output voltages V₀, V₁, Vₙ to produce the single feedback signal 116. The feedback signal 116 may be provided to the switching regulator 242 to control operation of the switching regulator 242, thus completing the feedback loop 108.

Operation of the switched mode power supply 200 will now be discussed with reference to FIGS. 2 and 2A. The switching regulator 242 monitors changes in the output voltages V₀, V₁. The output voltages V₀, V₁ may vary during circuit operation, for example, due to changes in the input voltage V_{IN}. In some situations, changes in the loads (e.g., load current) at the output terminals 112 may change the output voltages V₀, V₁, and son on. Operation of the switching regulator 242 attempts to drive the output voltages V₀, V₁ to a target by switching the switching device 244 ON and OFF using control signal 114 to vary the amount of energy that is transferred from the primary 224 to the secondaries 226, 226a. In some embodiments, the control signal 114 may be a square wave having a given switching frequency. Regulation of output voltages V₀, V₁ can be achieved by varying the duty cycle (e.g., the proportion of each switching period that the switching device 244 is ON) of the control signal 114 in response to feedback signal 116.

In accordance with some embodiments of the present disclosure, a single feedback signal 116 may be generated from the multiple output voltages V₀, V₁. For example, the combiner circuit 106 may sense the voltage levels of output voltages V₀, V₁ to produce a voltage level based on the output voltages V₀, V₁. Examples of combiner circuit 106 in accordance with embodiments of the present disclosure are described below. The voltage level generated in the combiner circuit 106 may be provided as feedback signal 116 to the switching regulator 242. The feedback signal 116 varies as the output voltages V₀, V₁ vary, and thus may be used by the switching regulator 242 to monitor changes in the output voltages V₀, V₁.

The reference voltage V_{ref} may serve as the target that the switching regulator 242 will use to regulate the output voltages V₀, V₁. In the switching regulator 242 (FIG. 2A), for example, the error amplifier 252 may subtract the feedback signal 116 from the reference voltage V_{ref} to produce an error signal Vₑᵣᵣ. The comparator 254 may compare the error signal Vₑᵣᵣ to the output of ramp oscillator 256 (e.g., a triangle wave, or other suitable waveform) to produce a square wave signal that can serve as control signal 114 to operate switching device 244. The magnitude of the error signal Vₑᵣᵣ will determine the duty cycle of the square wave, thus affecting the duration of the ON state and OFF state of the switching device 244. When the output voltages V₀, V₁ increase or decrease, the resulting feedback signal 116 will increase or decrease. Deviations of the feedback signal 116 from the reference voltage V_{ref} will create an error signal Vₑᵣᵣ that is proportional to the deviations from the reference voltage V_{ref}. The duty cycle of the square wave varies according to the magnitude of the error signal Vₑᵣᵣ, which can move the output voltages V₀, V₁ in a direction to reduce the error signal, thus completing the feedback loop 108.

It can be seen that the combiner circuit 106 allows the switching regulator 242 to regulate the output voltages (e.g., V₀, V₁) of a multi-output switched mode power supply (e.g., 200) based on a combination of the output voltages being regulated. Accordingly, each of the output voltages can contribute to the regulation of the output. Consequently, no one of the output voltages V₀, V₁ will solely influence regulation of the other output voltages. By comparison, conventional multiple output switching regulators that have a single control loop (e.g., single controller on a single feedback loop), may use only one of the output(s) (referred to as the master output) in the feedback loop. The master output is regulated with respect to a reference (e.g., V_{ref}), while the other outputs (referred to as slaved outputs) simply depend on regulation of the master output. Accordingly, the slaved outputs are subject to various adverse influences and may exhibit a larger margin of error than that of the mater output. For example, while the master output may be held constant because it is being regulated, the slaved outputs may change as the load current in the master output changes (referred to as cross-regulation). Another example of an adverse influence occurs when respective loads on the slaved outputs vary during circuit operation. Since the slaved outputs are not regulated, they can be influenced by their respective loading conditions. Circuit tolerances in the components of the switching regulator can contribute to errors in the slaved outputs. For the reasons discussed above, a switching regulator in accordance with the present disclosure can avoid or reduce the effects of these adverse influences.

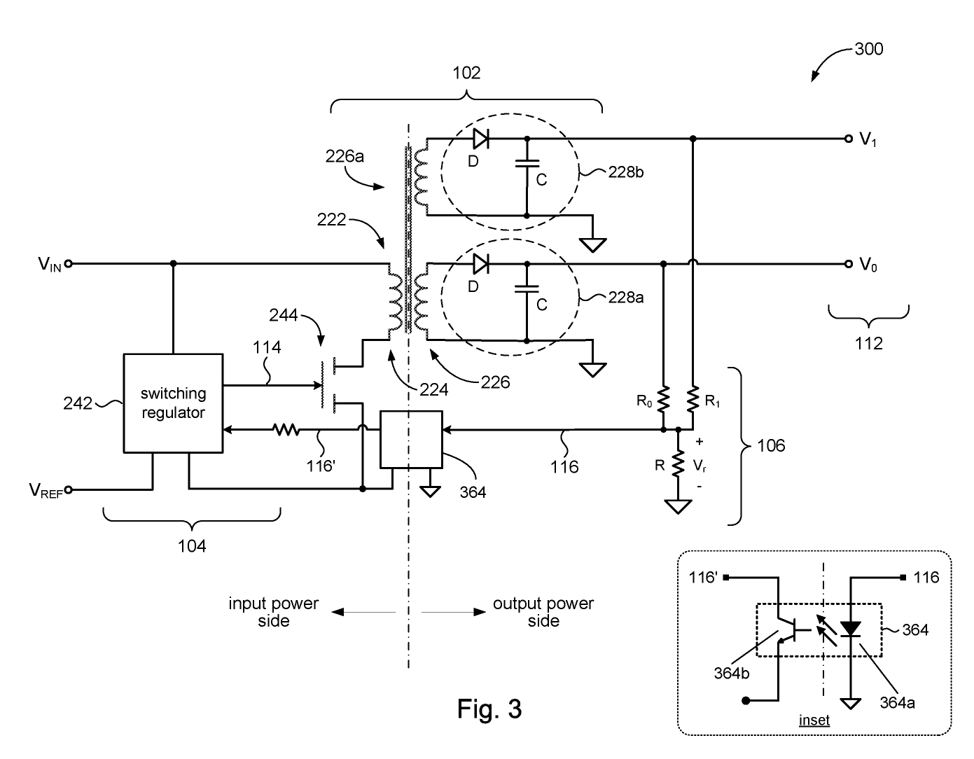

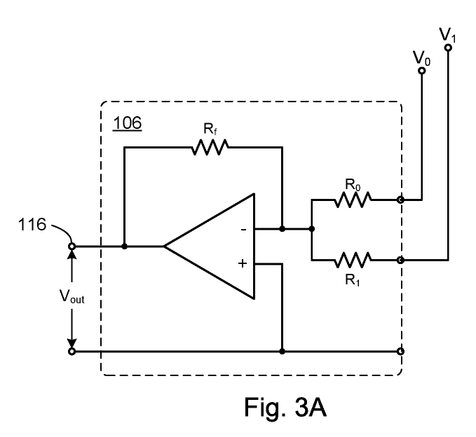

FIG. 3 shows some details of an example of a switched mode power supply 300 in accordance with other embodiments of the present disclosure. The switched mode power supply 300 may include power circuit 102 comprising switching device 244, transformer 222, and output modules 228a, 228b. The output module 228a may be connected across secondary 226 of transformer 222 to produce output voltage V₀. Likewise, the output module 228b may be connected across secondary 226a of transformer 222 to produce output voltage V₁. In some embodiments, each of the output modules 228a, 228b may include a diode rectifier D connected to capacitor C. The voltages across the capacitors C of output modules 228a, 228b may be provided on the output terminals 112 as respective output voltages V₀, V₁.

It will be appreciated that in other embodiments, the output modules 228a, 228b may use other circuit designs. In some embodiments, for example, the diode rectifier D may be implemented as a FET (not shown) and switched synchronously with switching of the switching device 244.

The switched mode power supply 300 may include controller 104 comprising switching regulator 242 and an optocoupler 364. The optocoupler 364 can provide electrical isolation between the input power side of the switched mode power supply 300 and the output power side of the switched mode power supply 300. For example, safety regulations may require potentially hazardous high input voltages on the input power side to be electrically isolated from the output power side. Transformer 222 (or other suitable inductive device) in the power circuit 102 can isolate the input voltage V_{IN} from output terminals 112. The optocoupler 364 can isolate combiner circuit 106 from the switching regulator 242 to prevent accidental shorting of a high input voltage on the input power side to the combiner circuit 106.

The inset in FIG. 3 shows details of an optocoupler 364, in accordance with some embodiments. Basically, current from the feedback signal 116 passes through an input LED 364a, which may emit an infra-red light whose intensity is proportional to the feedback signal 116. The emitted light falls upon the base of a photo-transistor 364b, causing it to switch ON and conduct in a similar way to a normal bipolar transistor. The base connection of the photo-transistor 364b can be left open for maximum sensitivity or connected to ground via a suitable external resistor (not shown) to control the switching sensitivity, making it more stable.

The switched mode power supply 300 may include combiner circuit 106 to combine output voltages V₀, V₁ produced by the output modules 228a, 228b to produce the feedback signal 116. As explained above, in some embodiments, it may be desirable to electrically isolate the input power side from the output power side of the switched mode power supply 300; e.g., to protect against a high input voltage. Accordingly, the feedback signal 116 may be provided to the optocoupler 364 to produce a corresponding feedback signal 116′ on the input power side that is electrically isolated from feedback signal 116 on the output power side.

In some embodiments, the combiner circuit 106 may comprise a passive circuit. In the particular embodiment shown in FIG. 3, for example, the combiner circuit 106 comprises a resistor network, and in particular, a resistor divider circuit. The contribution of each output voltage V₀, V₁ to the feedback signal 116 may be adjusted by selecting suitable values for the resistors R₀, R₁, and R that comprise the combiner circuit 106. In some embodiments, reactive elements (not shown) such as capacitors and/or inductors may be added to enhance the operation of the combiner circuit 106. If phase lag is a concern, for instance, the combiner circuit 106 may include a phase advance circuit to compensate for the phase lag. For example, the combiner circuit 106 may include one or more capacitors in parallel with resistors R₀, R₁ to provide phase advance compensation.

Referring to FIG. 3A, in other embodiments, combiner circuit 106 may be an active circuit. The combiner circuit 106, for example, may comprise an op-amp configured as a summing circuit. The summing circuit may sum together weighted output voltages V₀, V₁ to produce a summed output that can serve as the feedback signal 116. Selection of resistors R_{f}, R₀, and R₁ may control the weighting of each output voltage V₀, V₁. For example, the weighting for output voltage V₀ may be defined as R_{f}/R₀ and the weighting for output voltage V₁ may be defined as R_{f}/R₁. The feedback signal 116 may be a voltage level defined by

$$- ( {V}_{0} ( \frac{{R}_{f}}{{R}_{0}} ) + {V}_{1} ( \frac{{R}_{f}}{{R}_{1}} ) ) .$$

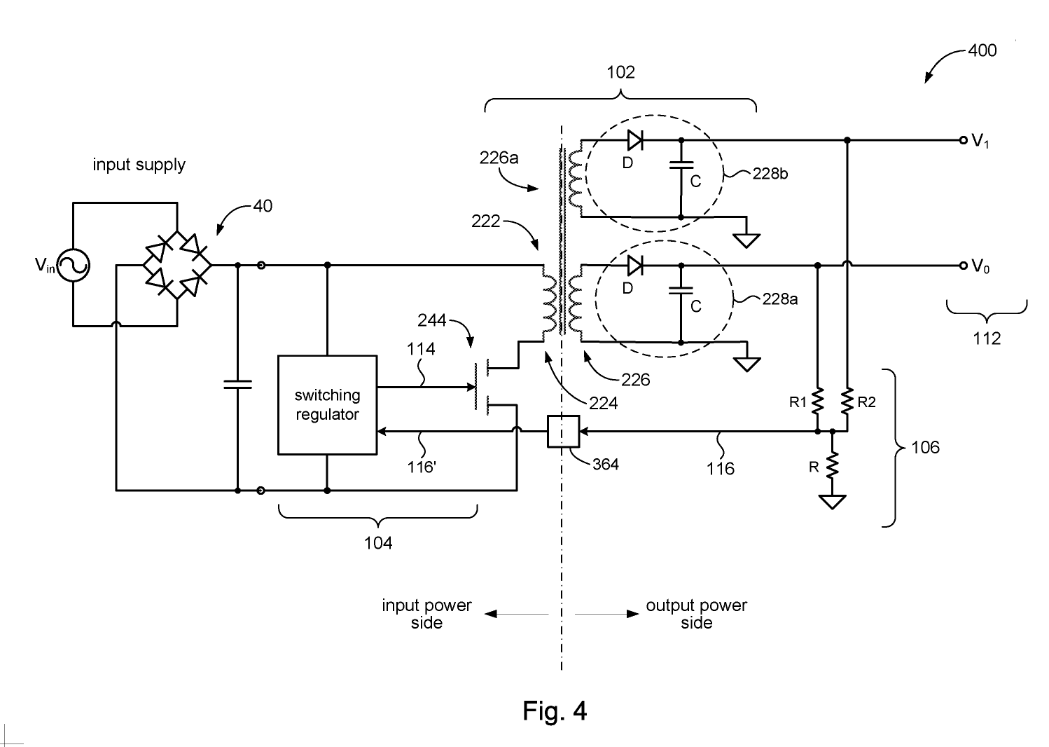

FIG. 4 shows that the input supply may be an AC voltage source. In some embodiments, for example the AC voltage source may be 120 VAC, such as might be found in the U.S. In other embodiments, the AC voltage source may be 240 VAC, such as might be found in other countries. More generally, the AC voltage source may be any suitable AC level. In some embodiments, an AC rectifier circuit 40 may be used to rectify and smooth the AC input voltage to produce a suitable DC voltage level.

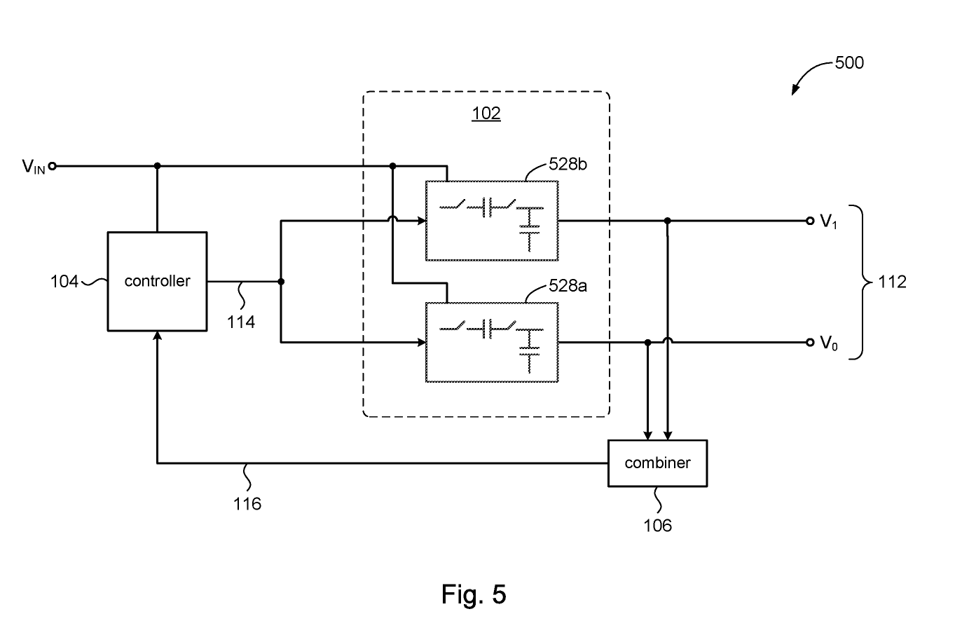

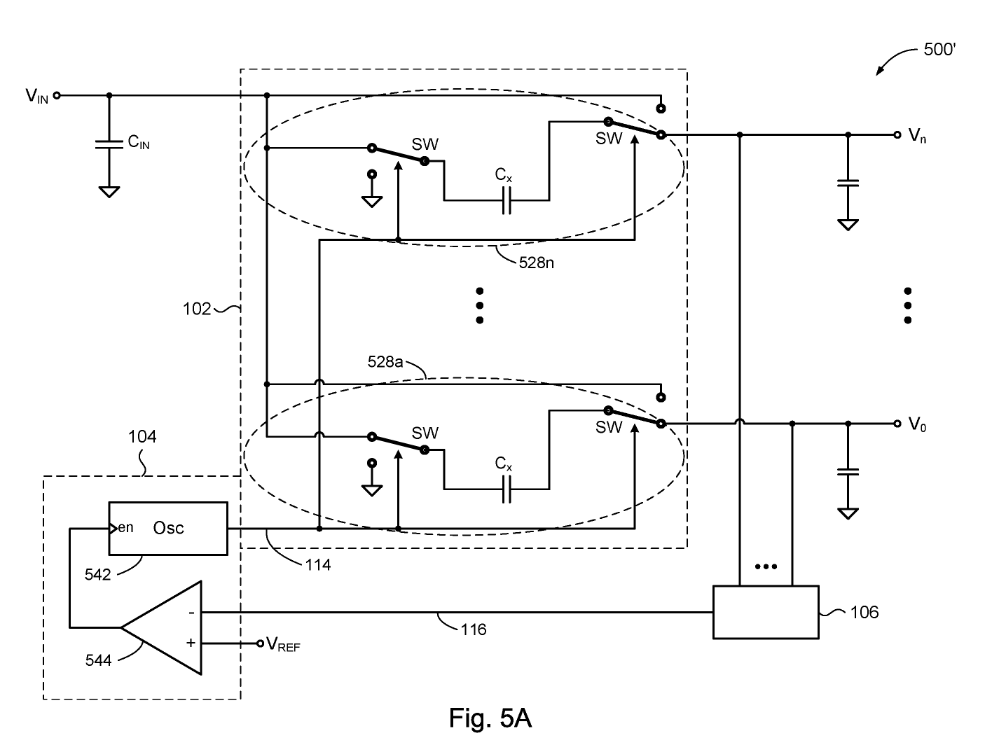

Referring to FIG. 5, in some embodiments, a switched mode power supply 500 in accordance with the present disclosure may be based on capacitive switching to produce regulated voltage outputs V₀, V₁, referred to as a switched capacitor converter. In some embodiments, for example, the switched mode power supply 500 may include power circuit 102 comprising several switched capacitor output modules 528a, 528b. A single controller 104 may control both output modules 528a, 528b using the same control signal 114. The output modules 528a, 528b, each, may include one or more switched capacitors that can be controlled by the control signal 114 to produce voltage outputs V₀, V₁.

FIG. 5A shows an example of a switched capacitor converter 500′ that provides voltage regulation by enabling and disabling an oscillator. The switched capacitor converter 500′ may be a multi-output power supply providing output voltages V₀-Vₙ. The power circuit 102 may comprise switched capacitor output modules 528a-528n to produce respective output voltages V₀-Vₙ. Each switched capacitor output module 528a-528n may include a capacitor Cₓ switched by switches SW between the input voltage V_{IN} and ground. The controller 104 may comprise an oscillator 542 and an error amplifier 544.

The oscillator 542 in controller 104 may generate oscillations (e.g., square waves) that serve as a control signal 104 to control the switched states of switches SW in the switched capacitor output modules 528a-528n. The switching of switches SW in the switched capacitor output modules 528a-528n between a first switched state and a second switched state controls the charging and discharging of the capacitors Cₓ, which can vary respective output voltages V₀-Vₙ.

An output of the error amplifier 544 in controller 104 may be connected to an ENABLE input (en) of the oscillator 542 to start and stop the production of oscillations from oscillator 542. The error amplifier 544 can therefore control charging and discharging of the capacitors Cₓ to vary the respective output voltages V₀-Vₙ.

The combiner circuit 106 may combine several of the produce a feedback signal 116. As explained above, the feedback signal 116 may represent a weighted combination of the output voltages V₀-Vₙ.

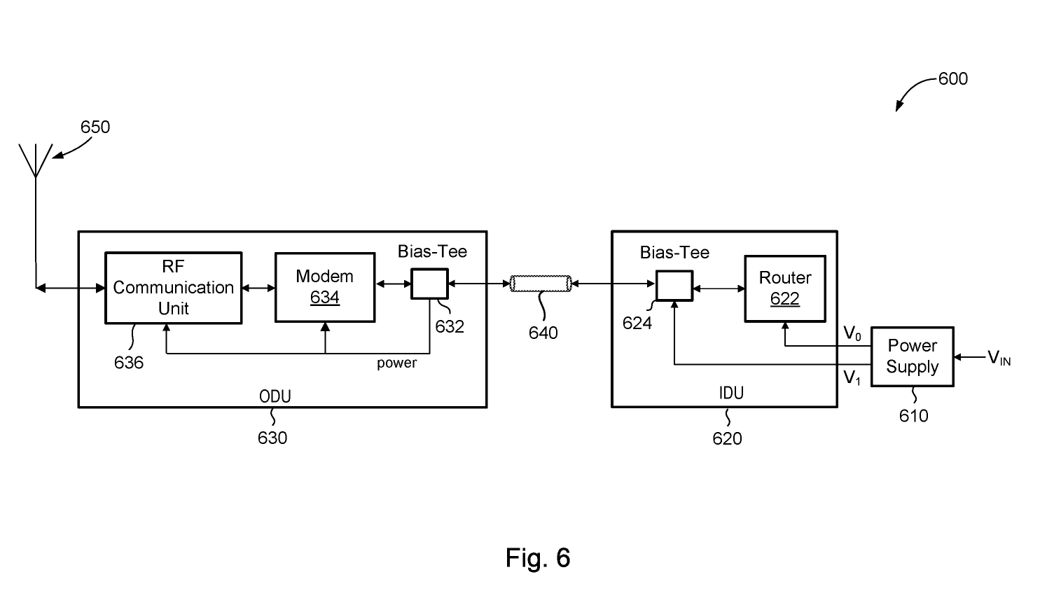

FIG. 6 shows a block diagram illustrating example components of a satellite user terminal 600 including a multi-output switched mode power supply 610 for providing power to an indoor unit (IDU) 620 and an outdoor unit (ODU) 630 in accordance with the present disclosure. The multi-output switched mode power supply 610 may be an example of aspects of switched mode power supply 100 described with reference to FIG. 1. In the illustrated example, the multi-output switched mode power supply 610 may output two regulated output voltages V₀, V₁ from an input voltage V_{IN} using the techniques described herein. Alternatively, the number of regulated output voltages may be greater than two.

The ODU 630 may be communicatively coupled to the IDU 620 via a communication link 640. In the illustrated example, the communication link 640 may be a single coaxial cable that facilitates communication of data between the ODU 630 and IDU 620. In some alternative examples, the communication link 640 may include multiple coaxial cables. As described in more detail below, in this example the communication link 640 may facilitate delivery of power to the ODU 630 using regulated output voltage V₁. In alternative examples, rather than multiplexing the power and data onto the same cable, the power may be delivered to the ODU 630 using a cable separate from the cable used to communicate data between the ODU 630 and IDU 620.

In the illustrated example, the IDU 620 may include a router 622 and a bias-tee 624. Many other configurations are possible having more or fewer components than the IDU 620 shown in FIG. 6. As shown in FIG. 6, the router 622 may be powered by regulated output voltage V₀ from the multi-output switched mode power supply 610. The router 622 can include a modem (not shown) to communicate data between the ODU 630 and one or more end user devices (not shown), such as laptop computers, tablets, mobile phones, etc., to provide bidirectional data communications, such as two-way Internet. The bias-tee 624 may facilitate communication of data between the router 622 and the communication link 640, while also inserting a power signal from regulated output voltage V₁ onto communication link 640 for powering the ODU 630.

In the illustrated example, the ODU 630 may include bias-tee 632, modem 634 and RF communication unit 636. Many other configurations are possible having more or fewer components than the ODU 630 shown in FIG. 6. Bias-tee 632 may facilitate communication of data between the modem 634 and the communication link 640, while also extracting the power signal from the communication link 640 to power the modem 634 and RF communication unit 636 of the ODU 630. The RF communication unit 636 may be configured to wirelessly communicate with a satellite (not shown) or other target through an antenna 650. The RF communication unit 636 may also include RF electronics to perform digital to analog (DAC) and analog to digital (ADC) conversion, up/down conversion, power amplifier (PA)/low noise amplifier (LNA) functions, and signal conditioning/filtering.

The modem 634 may perform encoding/modulation, error correction, control functions, data buffering memory, interfacing with the RF communication unit 636 and communicating data with the IDU 620. In some alternate examples, some or all of the functions may be implemented in IDU 620, either inside the router 622 or as a separate circuit or processing logic (not shown).

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

1. A multi-output switched mode power supply comprising:
input terminals for connection to an AC voltage source;
a rectifier circuit connected to the input terminals to rectify the AC voltage source to produce a DC voltage;
a power circuit connected to the rectifier circuit to receive the DC voltage, the power circuit having at least a first output terminal and a second output terminal;
a controller to control the power circuit to produce a first regulated voltage on the first output terminal and a second regulated voltage on the second output terminal;
a combiner circuit to produce a single feedback signal based on the first regulated voltage on the first output terminal and the second regulated voltage on the second output terminal; and
an optocoupler having an input to receive the single feedback signal and an output connected to the controller to produce a corresponding feedback signal electrically isolated from the single feedback signal,
wherein the controller is responsive to the corresponding feedback signal to control the power circuit to adjust the first regulated voltage and the second regulated voltage based on the DC voltage.

2. The multi-output switched mode power supply of claim 1, wherein the controller is responsive to a difference between the corresponding feedback signal and a reference signal to control the power module.

3. The multi-output switched mode power supply of claim 1, the combiner circuit to produce the single feedback signal based on a weighting of the first regulated voltage and the second regulated voltage.

4. The multi-output switched mode power supply of claim 1, wherein the first regulated voltage is different than the second regulated voltage.

5. The multi-output switched mode power supply of claim 1, the controller to generate a single switching control signal based on the corresponding feedback signal, the power circuit includes an input terminal to receive an input voltage, and the first regulated voltage and the second regulated voltage are each based on the input voltage and the single switching control signal.

6. The multi-output switched mode power supply of claim 1, further comprising a single feedback path between the combiner circuit and the controller to communicate the single feedback signal.

7. The multi-output switched mode power supply of claim 1, wherein the combiner circuit is a passive circuit or an active circuit.

8. (canceled)

9. The multi-output switched mode power supply of claim 1, wherein the power circuit comprises a switching element and an inductive component, the switching element to control a flow of current through the inductive component in response to a single switching control signal from the controller to produce the first regulated voltage and the second regulated voltage.

10. The multi-output switched mode power supply of claim 9, wherein the inductive component comprises a transformer including an input and first and second outputs, the switching element coupled to the input of the transformer, the first regulated voltage produced from the first output of the transformer, the second regulated voltage produced from the second output of the transformer.

11. The multi-output switched mode power supply of claim 1, wherein the power circuit comprises a first switched capacitor circuit and a second switched capacitor circuit to receive a single switching control signal from the controller, wherein the single switching control signal is based on the corresponding feedback signal, the first switched capacitor circuit to produce the first regulated voltage based on the single switching control signal, and the second switched capacitor circuit to produce the second regulated voltage based on the single switching control signal.

12. The multi-output switched mode power supply of claim 1, wherein the power circuit comprises a first output module to produce the first regulated voltage and a second output module to produce the second regulated voltage, each of the first and second output modules comprising a rectifier and a filter.

13. A method in a multi-output switched mode power supply comprising:
receiving an AC voltage source;
rectifying the AC voltage source to produce a DC voltage source;
generating at least a first regulated voltage and a second regulated voltage from the DC voltage source using a single controller;
providing the first regulated voltage and the second regulated voltage on a first output and a second output, respectively, of the multi-output switched mode power supply;
producing a single feedback signal based on the first regulated voltage and the second regulated voltage;
producing a corresponding feedback signal that is electrically isolated from the single feedback signal; and
using the single controller to adjust the first regulated voltage and the second regulated voltage based on the corresponding feedback signal.

14. The method of claim 13, further comprising producing in the single controller a difference between the corresponding feedback signal and a reference signal and adjusting the first regulated voltage and the second regulated voltage based on the difference.

15. The method of claim 13, wherein the single feedback signal represents a weighting of the first regulated voltage and the second regulated voltage.

16. The method of claim 13, wherein the first regulated voltage is different than the second regulated voltage.

17. (canceled)

18. The method of claim 13, further comprising controlling a flow of current through an inductive component using the single controller to produce the first regulated voltage and the second regulated voltage.

19. The method of claim 13, wherein generating the first regulated voltage and the second regulated voltage includes controlling a flow of current through a primary of a transformer, wherein the first regulated voltage is an output of a first secondary of the transformer and the second regulated voltage is an output of a second secondary of the transformer.

20. The method of claim 13, further comprising controlling a first switched capacitor circuit and using the corresponding feedback signal to produce the first regulated voltage and controlling a second switched capacitor circuit and using the corresponding feedback signal to produce the second regulated voltage.

21. A multi-output switched mode power supply comprising:
means for receiving an AC voltage source;
means for rectifying the AC voltage source to produce a DC voltage source;
means for generating at least a first regulated voltage and a second regulated voltage from the DC voltage source;
means for outputting the first regulated voltage and the second regulated voltage, respectively, on a first output and a second output;
means for producing a single feedback signal based on the first regulated voltage and the second regulated voltage;
means for producing a corresponding feedback signal that is electrically isolated from the single feedback signal; and
means for adjusting the first regulated voltage and the second regulated voltage based on the single feedback signal.

22. The switched mode power supply of claim 21, wherein the means for producing a single feedback signal comprises a resistor network electrically connected to the first output and the second output.

23. The switched mode power supply of claim 21, wherein the means for producing a single feedback signal comprises a summing circuit to sum together a voltage on the first output and a voltage on the second output.

24. The multi-output switched mode power supply of claim 1, wherein the combiner circuit comprises an op-amp as a summing circuit to produce the signal feedback signal as a sum of the first regulated voltage and the second regulated voltage.

25. The method of claim 13, wherein producing a single feedback signal includes using an op-amp as a summing circuit to sum together the first regulated voltage and the second regulated voltage.
